(19) United States
(12) Patent Application Publication
(10) Pub. No.: US 2012/0160162 A1
(43) Pub. Date: Jun. 28, 2012

(54) COATING DEVICE

(75) Inventor: CHIA-YING WU, Tu-Cheng (TW)

(73) Assignee: HON HAI PRECISION INDUSTRY CO., LTD., Tu-Cheng (TW)

(21) Appl. No.: 13/071,532

(22) Filed: Mar. 25, 2011

(30) Foreign Application Priority Data
Dec. 24, 2010 (TW) 99145700

(51) Int. Cl. B05C 13/00; B05C 11/00

(52) U.S. Cl. 118/500

(57) ABSTRACT

A coating device includes a shell, a plurality of shaft groups, a plurality of first bases, a second base, and a driving device. The shell defines a coating chamber. The shaft groups are parallelly arranged in a first circle and housed in the coating chamber. Each shaft group includes a plurality of holding shafts parallelly arranged in a second circle and configured for holding workpieces. The first bases are housed in the coating chamber and surround the shaft groups. The second base is housed in the coating chamber and surrounded by the shaft groups. The first and second bases are configured for receiving targets. The driving device is configured for driving each holding shaft to spin.

### BACKGROUND

1. Technical Field

The present disclosure relates to coating technology and, particularly, to a coating device.

2. Description of Related Art

Coating devices generally include a shell defining a coating chamber, a number of holding shafts housed in the coating chamber for holding workpieces, and a set of holders received in the coating chamber for seating targets. The holders surround and face the holding shafts. In operation, the workpieces are seated on the holding shafts, facing the targets and capturing atomic particles of the targets, thereby forming a desired film. To ensure uniformity of the films on the workpieces, currently, all the holding shafts are parallelly arranged in a circle which is centered inside the bases. However, such an arrangement of the holding shafts does not efficiently use the space of the coating chamber and results in a low yield.

Therefore, it is desirable to provide a coating device, which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a top planar schematic view of a coating device, in accordance with an exemplary embodiment.

FIG. 2 is a cross-sectional schematic view of the coating device of FIG. 1.

### DETAILED DESCRIPTION

Embodiments of the present disclosure will now be described in detail with reference to the drawings.

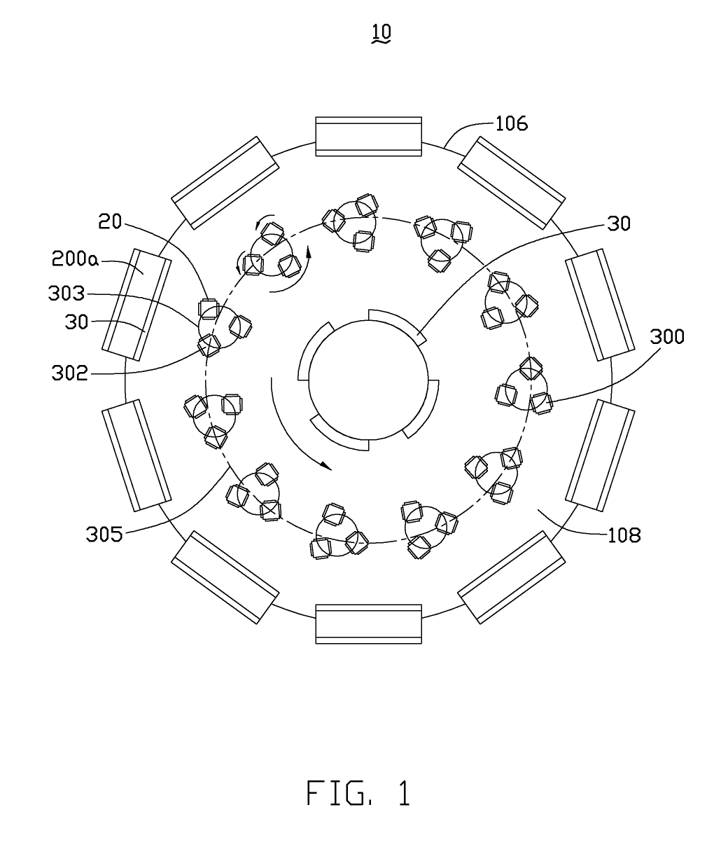

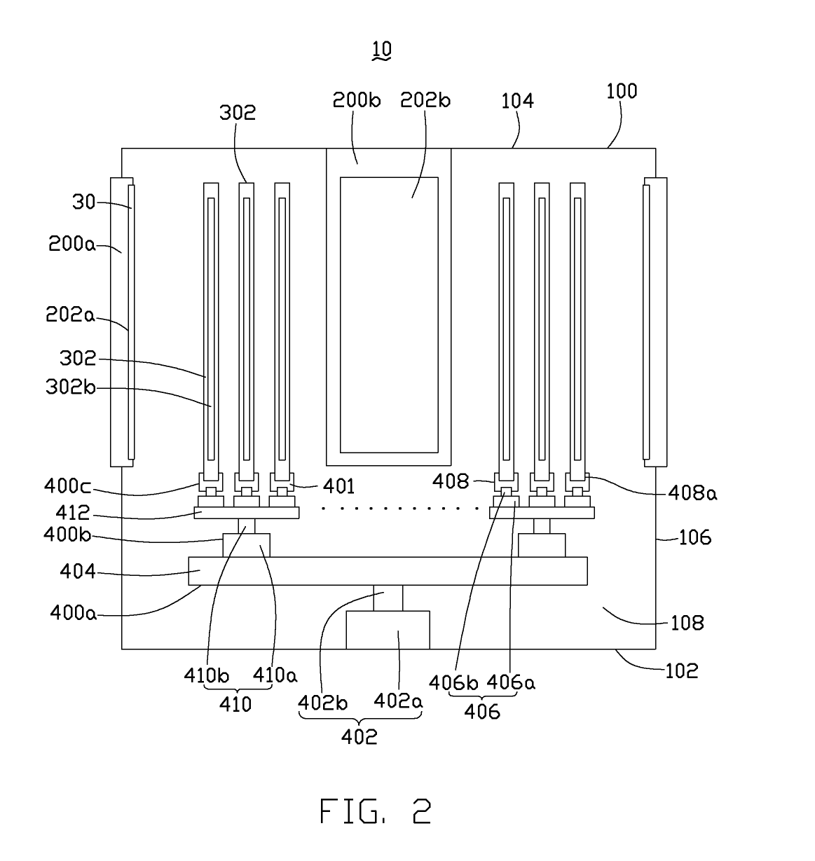

Referring to FIGS. 1 and 2, a coating device 10, according to an exemplary embodiment, includes a shell 100, a number of first bases 200a, a second base 200b, a number of shaft groups 300, a first driving device 400a, a number of second driving devices 400b, and a third driving device 400c.

The shell 100 includes a bottom plate 102, a top plate 104 opposing the bottom plate 102, and a round side plate 106 connecting the bottom plate 102 and the top plate 104. The bottom plate 102, the top plate 104, and the side plate 106 cooperatively form a cylindrical coating chamber 108 for coating workpieces.

Each of the first bases 200a is substantially cuboid and forms a first groove 202a thereon for holding targets 30. The first bases 200a are equidistantly fixed on the side plate 106 with the first grooves 202a opposing the axis of the coating chamber 108.

The second base 200b is substantially cylindrical and forms a number of second grooves 202b on the sidewall thereof for holding targets 30. The second base 200b is fixed on the top plate 104 along the axis of the coating chamber 108 with the second grooves 202b opposing the first bases 200a.

The first driving device 400a includes a first motor 402 and a first board 404. The first motor 402 includes a first base 402a fixed on the center of the bottom plate 102 and a first shaft 402b rotated by the first base 402a. The first board 404 is substantially circular and the center of the first board is connected to the first shaft 402b. The first motor 402 rotates the first board 404 counterclockwise as viewed from the top plate 104.

Each of the second driving devices 400b includes a second motor 410 and a second board 412. The second motor 410 includes a second base 410a and a second shaft 410b rotated by the second base 410a. The second bases 410a are equidistantly fixed on the edge of the first board 404, separately arranged on a first circle 305. The second board 412 is substantially circular and the center of the second board 412 is connected to the second shaft 410b. The second motor 410 rotates the second board 412 counterclockwise as viewed from the top plate 104.

The third driving device 400c includes a number of driving groups 401. Each of the driving groups 401 includes three third motors 406 and three third boards 408. The third motor 406 includes a third base 406a and a third shaft 406b rotated by the third base 406a. The third board 408 is substantially circular and defines a third groove 408a on a side thereof. Three third bases 406a of a driving group 401 are equidistantly fixed on the edge of the second board 412, thereby separately arranged on a second circle 303. The center of a side of the third board 408 facing away from the third groove 408a is connected to the third shaft 406b. The third motor 406 rotates the third board 408 counterclockwise as viewed from the top plate 104.

Each of the shaft groups 300 includes three substantially cuboid holding shafts 302. Each of the four surfaces 304 of the holding shaft 302 is substantially parallel to the axis of the holding shaft 302 and forms a slot 302b for seating the workpiece 20. An end of the holding shaft 302 is received in a corresponding third groove 408a. As such, the holding shafts 302 in the same shaft group 300 are substantially parallel to the axis of the chamber 108 and separately arranged on the second circle 303 at regular angular intervals. The shaft groups 300 are substantially parallel to each other and separately arranged on the first circle 305 at regular angular intervals. The first circle 305 centers the axis of the coating chamber 108, surrounding the second base 200b and surrounded by the first bases 200a.

In operation, targets 30 are received in the first grooves 202a and the second grooves 202b, the workpieces 20 are received in the slots 302b. A negative voltage is applied on the targets 30 while a positive voltage is applied on the workpieces 20 thereby electronic fields are generated between the targets 30 and the workpieces 20. Each third motor 406 rotates a corresponding holding shaft 302 about the axis of the holding shaft 302. Each second driving device 400b rotates a respective shaft group 300 about the axis of the second circle 303. The first driving device 400a rotates the shaft groups 300 about the axis of the coating chamber 108. Working gas (such as Argon) that ionized in the electronic field and reactive gas that reacts with the atomic particles of the targets flow into the coating chamber 108. In the electronic field, the argon is ionized to argon ions and electrons. The argon ions are accelerated to bombard the targets 30, thereby the targets 30 release atomic particles. The particles react with the reactive gas to form compounds. The compounds deposit on a surface of the workpieces 20 facing outwards, forming a desired film.

In the present disclosure, each three holding shafts 302 are arranged on the second circle 303 to form a shaft group 300 while a number of the shaft groups 300 are arranged on the first circle 305, which make more efficient use of the coating chamber 108. As such, the coating efficiency of the coating device 10 is improved.

Meanwhile, as the each of the holding shafts 302 rotates about the axis thereof and revolves around the axis of the second circle 303, and each of the shafts groups 300 rotates about the axis of the first circle 305, the thicknesses of the films deposited on the workpieces 20 are substantially uniform, whereby the coating quality of the coating device 10 is improved.

Because the holding shafts 302 distance from each other, the shaft groups 300 are arranged separately, and the targets 30 on the first base 200a and the targets 30 on the second base 200b sandwich the holding shafts 302. Therefore, as long as the holding shafts 302 rotate about the axis, the workpieces 20 on the holding shafts 302 can also gain an even film. Therefore, in alternative embodiments, the first driving device 400a and the second driving device 400b can be omitted.

The holding shafts 302 of each shaft groups 300 are arranged on a second circle 303 for the sake of making efficient use of the coating chamber 108. Therefore, in alternative embodiments, the number of holding shafts 302 in a shaft group 300 can be adjusted according to practical use, also can the number of the shaft groups 300.

The holding shafts 302 rotate to receive an even film. Therefore, the rotate direction is not limited to the present disclosure.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A coating device, comprising:
a shell defining a coating chamber;
a plurality of shaft groups parallelly arranged in a first circle and housed in the coating chamber, each shaft group comprising a plurality of holding shafts parallelly arranged in a second circle and configured for holding workpieces;
a plurality of first bases housed in the coating chamber and surrounding the shaft groups;
a second base housed in the coating chamber and surrounded by the shaft groups; the first and second bases being configured for receiving targets; and
a first driving device configured for driving each holding shaft to spin.

2. The coating device of claim 1, wherein each holding shaft is substantially cuboid and has four side surfaces, and each of the four side surfaces defines a slot for holding a workpiece.

3. The coating device of claim 1, wherein the shell comprises a bottom plate, a top plate facing the bottom plate, and a side plate connecting the bottom plate and the top plate; the bottom plate, the top plate, and the side plate cooperatively define the coating chamber.

4. The coating device of claim 3, wherein the coating chamber is substantially cylindrical and defines a central axis.

5. The coating device of claim 4, wherein each holding shaft is substantially parallel to the central axis.

6. The coating device of claim 4, wherein each of the first bases is substantially cuboid and defines a first groove therein, and the first bases are equidistantly fixed on the side plate with the first grooves facing the central axis.

7. The coating device of claim 4, wherein the second base is substantially cylindrical and defines a plurality of second grooves on the side wall thereof, and the second base is fixed on the top plate along the central axis with the second grooves facing the first bases.

8. The coating device of claim 4, wherein the first driving device comprises a plurality of driving groups, each of the driving groups is connected to a corresponding shaft group and configured for rotating the corresponding shaft group to spin.

9. The coating device of claim 8, wherein each of the driving groups comprises a plurality of first motors and a plurality of first boards; each first motor comprises a first base and a first shaft connecting to the first base along the central axis; each first board is substantially circular and defines a first groove on a side thereof receiving a corresponding holding shaft, the first bases of each driving group are equidistantly arranged along the second circle in the coating chamber, each first shaft is connected to a center of a corresponding first board and is opposite to the first groove of the corresponding first board.

10. The coating device of claim 9, further comprising a plurality of second driving devices, wherein each of the second driving devices is connected to a corresponding driving group and configured for rotating the corresponding driving group about the axis of the second circle.

11. The coating device of claim 10, wherein each second driving device comprises a second motor and a second board; the second motor comprises a second base and a second shaft connecting to the second base along the central axis, the second bases of the second driving devices are equidistantly arranged along the first circle, each second board is substantially circular, a center of each second board is connected to a corresponding second shaft; each of the driving groups is fixed on a corresponding second board.

12. The coating device of claim 11 further comprising a third driving device, wherein the first driving device is connected to the second driving devices and configured for rotating the shaft groups about the axis of the first circle.

13. The coating device of claim 12, wherein the third driving device comprises a third motor and a third board; the third motor comprises a third base received in the coating chamber and a third shaft connecting to the third base along the central axis, the third base is positioned on the bottom plate, the third board is substantially circular, a center of the third board is connected to the third shaft; the second driving devices are positioned on the third board.
